(19) United States
(12) Patent Application Publication
(10) Pub. No.: US 2010/0219258 A1
(43) Pub. Date: Sep. 2, 2010

(54) HVAC DISINFECTION AND AROMATIZATION SYSTEM

(76) Inventor: Mario Starcic, Zagreb (HR)

Correspondence Address: DAVIS WRIGHT TREMAINE, LLP/Seattle, 1201 Third Avenue, Suite 2200, SEATTLE, WA, 98101-3045, US

(21) Appl. No.: 12/395,416

(22) Filed: Feb. 27, 2009

(51) Int. Cl. B05B 12/08; B05B 15/00

(52) U.S. Cl. 239/1; 239/75; 239/302; 239/289

(57) ABSTRACT

A system for automatic disinfection and/or aromatization of an HVAC system having a reservoir for holding disinfection or aromatization fluid, an airflow sensor, a pump, an injection apparatus and control module. The airflow sensor and injection apparatus are configured to be coupled to an HVAC duct. The control module is configured to compute the mass of air flowing through such a duct, deliver fluid from the reservoir to the injection apparatus, and to control the injection apparatus so as to inject a quantity of fluid into the duct that is a function of the computed mass of air flowing through the duct.

### FIELD OF THE INVENTION

The present invention relates to a system for disinfection and aromatization of heating, ventilation and air conditioning (HVAC) systems. More particularly, the invention relates to a system for automatically and regularly disinfecting and/or aromatizing HVAC ducts, and the air that flows through them, wherein embodiments of the invention operate independently of the HVAC system.

### BACKGROUND OF THE INVENTION

Broadly speaking, heating, ventilation and air conditioning (HVAC) systems include a centralized heating and/or air-conditioning unit connected to a blower motor that circulates heated or cooled air throughout a building via ducts. Centralized systems enjoy widespread use in a number of settings including buildings, cruise ships, and other suitable transportation vehicles, due to a number of advantages such systems have over unit ventilators and/or individual heat pumps or heaters. For example, centralized HVAC systems are quieter, less drafty due to multiple air supplies and an air return that is away from room occupants, easier to maintain due to relatively few components and often have space for higher efficiency air filters. In operation, much of the air within a building is recirculated while mixing the recirculated air with fresh air from an external source. Such recirculation reduces overall energy costs because the recirculated air need not be continuously heated or cooled from the outside ambient temperature, and need only be maintained at the proper interior temperature.

The recirculation of air, however, has certain drawbacks. Although HVAC systems have air filters to remove particulate matter from the airstream, the ventilation ducts of the HVAC system can become contaminated with bacteria, viruses and/or molds thereby contaminating the airflow which is directly sent into rooms where people are breathing. Contaminated HVAC ducts have been associated with so-called Sick Building Syndrome (SBS) as well as with Norwalk virus contamination on cruise ships. It is, therefore, necessary to take steps to prevent contamination, or once contamination has taken place, to disinfect the ductwork.

In the past, prevention of duct contamination has often required a complete shutdown of the HVAC system, sometimes for days, and laborious and expensive manual cleaning of the ducts. To help eliminate the need for this expensive and time consuming decontamination and/or prevention process, systems have been developed to permit at least semi-automated disinfection of HVAC ducts by introducing disinfectants into the air stream flowing through the ducts. Such systems have likewise been used to introduce aromas into the air stream flowing through the ducts, in order to aromatize the environment.

For example, U.S. Pat. No. 6,065,301 (“the '301 patent”) describes a system for introducing cleaning and/or aromatizing agents into the airstream of an automobile air-conditioning system. The system described in the '301 patent, however, relies on the driver to manually initiate the introduction of the agents by pushing a button. This method of manual introduction is not ideal because it is possible to push the button, and therefore introduce the agents, even when the airflow through the air-conditioning system is either too weak or nonexistent. Under such conditions, the cleaning or aromatizing agent could collect in the system without being distributed by an airstream. Also, manual introduction of the cleaning or aromatizing agent may lead to too much or not enough of such agents being introduced into the airstream. In other words, there is no correlation between the volume of air flowing in the system, and the amount of disinfectant or aromatizing agent being introduced.

U.S. Pat. No. 5,957,771 describes a mechanism that is integrated into the ventilation ducts of a central HVAC system, and permits introduction of an aromatizing agent into the ventilation airstream. The described mechanism, however, is wholly integrated into the central HVAC system and relies upon signaling and control from the central HVAC system itself in order to operate. Moreover, and similar to the '301 patent described above, the mechanism does not detect airflow speed or mass in order to control the amount of aromatizing agent introduced in the airstream.

U.S. Pat. No. 5,302,359 describes an apparatus for introducing an aromatizing agent into the airflow of an HVAC system. The aromatizing liquid is pumped into an absorptive material which is located inside the ventilation duct, and where the aromatizing liquid is then evaporated from the absorption material into the airstream. This apparatus has significant drawbacks. For example, the rate of evaporation from the absorptive material is difficult to predict and highly variable depending on the specific agent being used, and the air temperature and humidity of the airstream. Because of this, the amount of aromatizing agent being introduced into the airstream is also not correlated with the amount of air flowing through the ducts. Also the aromatizing agent is pumped into the absorptive material at predetermined intervals even if there is no airflow in the duct. If, for whatever reason, the airflow to the ducts is interrupted for an extended period of time, an excess of agent may overflow the absorptive material into the ducts.

International Patent Application No. PCT/DE2003/002757 describes a device which is connected to the central control module of a building ventilation system, and controls the introduction of disinfectant and/or aromatizing agents into the HVAC airstream. Because the described device relies on a connection to the central control module of the building ventilation system, the described system may not be readily retrofitted to existing HVAC systems and must instead be specifically engineered for whatever HVAC system is in place. The described device also does not disclose any means for detecting the specific amount or speed of airflow in the HVAC ducts. It is therefore not possible for the described device to accurately meter disinfectant or aromatizing agents into the airstream in a manner that is a function of the airflow.

There is therefore a need for a system that automatically aromatizes and/or disinfects an HVAC system by detecting and measuring the airflow through the HVAC ducts, and injecting an appropriate quantity of aroma or disinfectant agent into the airstream as a function of the measured airflow and independently of the HVAC system itself.

### BRIEF DESCRIPTION OF THE DRAWINGS

FIG. 1a is an isometric view of an HVAC injection apparatus according to an embodiment of the invention.

FIG. 1b is an enlarged front elevational view of the control module 120 showing in FIG. 1a.

FIG. 2a is an enlarged, isometric view of the duct airflow and injection interface module 110 as shown in FIG. 1a.

FIG. 2b is an enlarged, side view of the duct airflow and injection interface module 110 according to an example installation on an HVAC duct 105.

FIGS. 3a-3e are a series of operational flow charts depicting operation of an HVAC injection system or apparatus according to an embodiment of the invention.

FIG. 4 is a block diagram of an HVAC injection system according to an embodiment of the invention.

### DETAILED DESCRIPTION OF THE INVENTION

Embodiments are described below for automatically injecting a disinfectant or aromatizing agent into the airflow of an HVAC system. Although described in terms of a particular combination of components, it should be understood that such components are only exemplary. Other types of components may also be substituted in other embodiments of the invention.

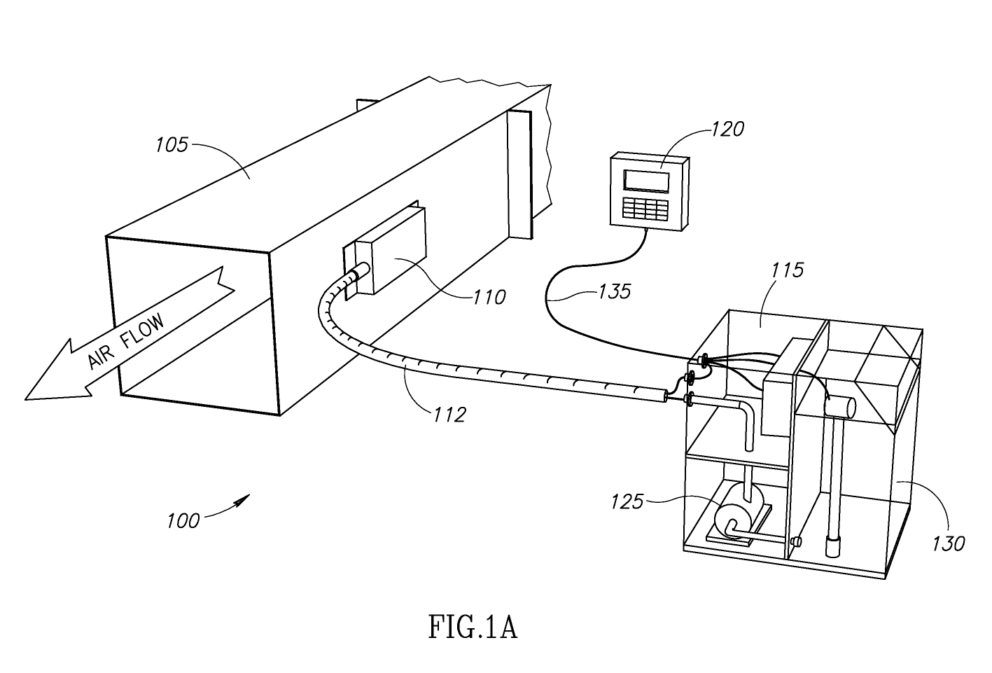

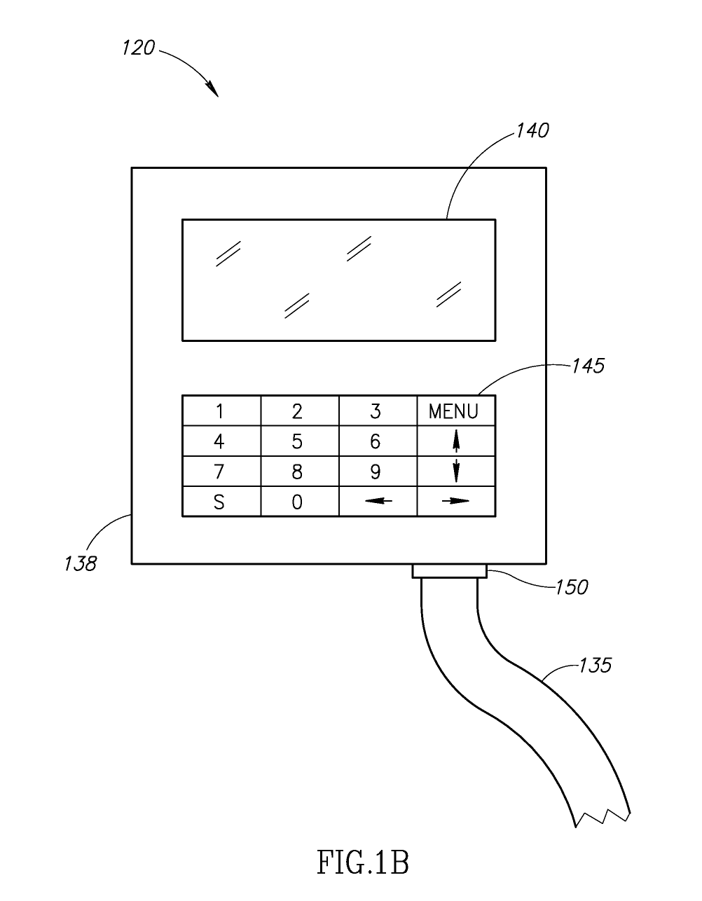

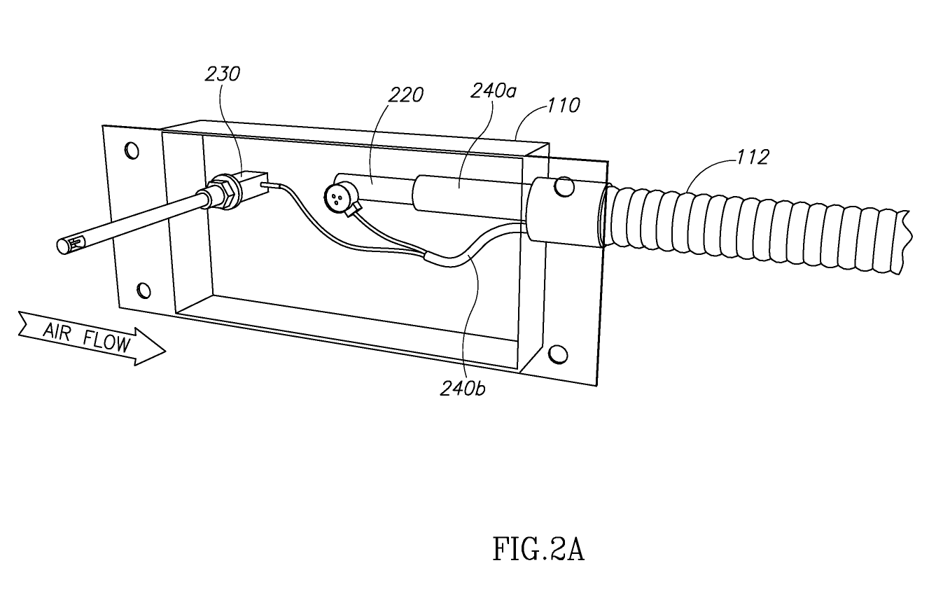

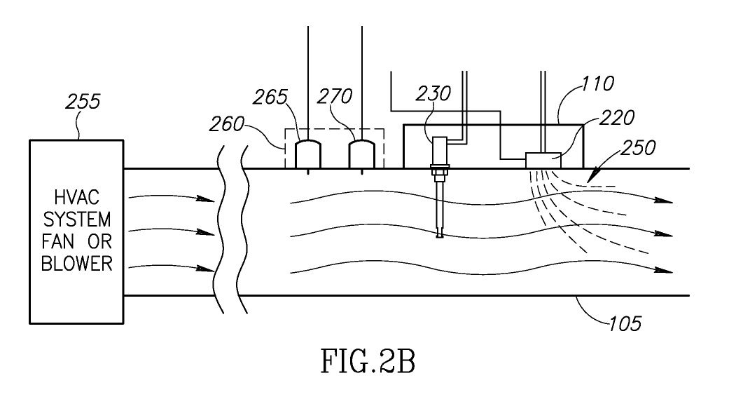

An HVAC injection apparatus 100 according to an embodiment of the invention is shown in FIG. 1a. The HVAC injection apparatus 100 includes a housing 115 coupled to a control module 120 and to an airflow and injection interface module 110. The airflow and injection interface module 110 is coupled to an HVAC duct 105. Although the control module 120 is shown coupled to the housing 115 by a cable 135, the control module may also be wirelessly coupled to the housing in certain embodiments. The housing 115 contains to pump 125 and a reservoir 130. The reservoir 130 is configured to hold a volume of disinfectant and/or aromatizing solution. The reservoir 130 is fluidly coupled to the pump 125 which is in turn fluidly coupled to an injection nozzle 220 shown in FIG. 2a in the duct airflow and injection interface module 110 by a hose contained in the cable and hose conduit 112. As will be more fully described below, the pump 125 is configured to pressurize the system with disinfectant and/or aromatizing solution thus permitting the solution to be injected into the HVAC duct 105 under certain conditions. The reservoir 130 is also equipped with a sensor, such as a float valve, that can detect when the fluid level in the reservoir 130 is becoming critically low. In that event, the control module 120 may alert the user to the low fluid level condition, and allow the user to add additional fluid. If the reservoir 130 runs completely dry of fluid, the control module 120 is typically configured to shut the system down to prevent electrical damage to the pump from a running in a dry state.

FIG. 1b depicts the control module 120 according to an embodiment of the invention. The control module 120 includes a housing 138. The control module housing 138 includes a cable jack 150 to interface with the cable 135 shown in FIG. 1a. Also shown on the front face of the control module housing 138 is a display 140, and a keypad 145. The display 140 is used to display menu choices and other operational data to the user as will be more fully described below. The display 140 may also be used to display operational aspects of the system while in use. For example, the display 140 may display the currently measured airflow speed through the HVAC duct 105, the airflow temperature, and the amount of liquid remaining in the reservoir 130. The keypad 145 enables the user to select menu choices and enter data in order to configure the system as also will be more fully described below. In an embodiment, the control module 120 also contains a temperature sensor (not shown) that will prevent the system from functioning if the temperature drops below a certain point. If, for example, the temperature were too low, the liquid disinfectant and/or aromatizing solution could freeze inside the hose and/or pump, and damage would result if the pump is actuated in such a state.

FIG. 2a depicts the duct airflow and injection interface module 110. The duct airflow and injection interface module 110 includes an airflow sensor 230 and the injection nozzle 220. Also shown is the cable and hose conduit 112 which couples the duct airflow and injection interface module 110 to the housing 115 as shown in FIG. 1a. The injection nozzle 220 is fluidly coupled to the housing 115 by a hose 240a. The airflow sensor 230 and injection nozzle 220 are also coupled to the housing 115 by the control and sensor cables 240b. It should be noted, that the inclusion of the airflow sensor 230 and injection nozzle 220 in the duct airflow and injection interface module 110 is purely exemplary. More specifically, having the sensor and injection nozzle placed within the duct airflow and injection interface module 110 is primarily for installation convenience. During installation, this configuration permits a single template to be placed on the HVAC duct 105, for the easy drilling of required installation mounting holes, and for the easy installation of air Arab duct airflow and injection interface module 110. In other embodiments, however, the airflow sensor 230 and injection nozzle 220 may be installed in completely separate locations. This may be beneficial in situations where the airflow sensor may be better placed to more accurately determine the rate of airflow in the duct. Also, overall system performance may be improved if the injection nozzle 220 is placed in an area where there is increased turbulence in the airflow thereby promoting efficient mixing of the injected liquid disinfectant and/or aromatizing solution with the passing airstream.

FIG. 2b depicts an enlarged side view of the duct airflow and injection interface module 110 coupled to the HVAC duct 105. This figure more precisely illustrates the physical arrangement of the airflow sensor 230 and injection nozzle 220 with respect to the HVAC duct 105. In particular, the airflow sensor 230 extends into the HVAC duct 105 upstream of the injection nozzle 220 to avoid the injected liquid wetting the airflow sensor and impacting its reading of airflow. The airflow sensor 230 is thus situated to detect the presence of airflow and measure the speed and/or mass of air flowing within the HVAC duct 105. In a typical embodiment, the airflow within the HVAC duct 105 is created by a fan or blower 255 within the HVAC system such as shown in FIG. 2b. The injection nozzle 220 is likewise coupled to the side of the HVAC duct 105 and under certain conditions and only when airflow is detected in the HVAC duct, as will be described more fully below, injects a predetermined amount of agent 250 into the HVAC duct. In practice, the duct airflow and injection interface module 110 is typically installed as close to the HVAC blower fan, and as far from the ventilation outputs, as is possible. This type of installation encourages the liquid disinfectant and/or aromatizing solution, referred to herein as, agent 250 completely mix with the airstream due to the transit time and turbulence within the HVAC duct 105, and helps distribute the agent throughout the ductwork. The duct airflow and injection interface module 110 may also include one or more optional sensors 260. For example, the duct airflow and injection interface module 110 may include a pressure sensor 265, or a temperature sensor 270. The use of these or other optional sensors may allow more accurate computation of the mass of air flowing through the HVAC duct 105. In an embodiment, the airflow sensor 230 may be virtually any type of airflow sensor. For example, the airflow sensor 230 may be a type of hotwire anemometer, cup anemometer, ultrasonic anemometer, laser anemometer, or some other type of impeller-based anemometer. In one embodiment the airflow sensor 230 is The SCHMIDT Stromungs-Sensor flow sensor model SS 20.260 by Schmidt Technology GmbH in Germany which measures both flow velocity and temperature, and eliminates the need for the separate temperature sensor 270.

In one embodiment, the injection nozzle 220 may function so as to aerosolize the disinfectant or aromatizing agent 250 during injection of the agent into the HVAC duct 105. Aerosolizing the agent during injection results in relatively large droplets of agent being present in the airstream. In other embodiments, however, the injection nozzle 220 may instead atomize the agent 250 during injection into the HVAC duct 105. Atomization of the agent during injection results in much smaller droplets of agent being present in the airstream. The choice of whether to aerosolize or atomize is application specific and also depends somewhat on the specific type of disinfectant or aromatizing agent 250 being used.

In an embodiment, the injection nozzle 220 may be an electromagnetic injection nozzle. An electromagnetic nozzle has certain advantages for this application. For example, a suitable electromagnetic injection nozzle has an electromagnetic valve integrated into, or inherent to, the operation of the electromagnetic injection nozzle. Functionally speaking, when the electromagnetic injection nozzle 220 stops injecting fluid into the HVAC duct 105, the electromagnetic valve closes in a very short period of time, typically on the order of 100 ms. The rapid closure of the electromagnetic valve ensures that there is no leaking or dripping of the agent 250 into the HVAC duct 105 after the injection nozzle 220 stops operating. The closure of the electromagnetic valve in the injection nozzle 220 also ensures that no liquid returns to the reservoir when the injection nozzle 220 stops operating. This functionality is useful because when the time comes for the injection nozzle 220 to again begin spraying agent 250 into the HVAC duct 105, it takes very little time for the pump 125 to bring the system up to full pressure. Likewise, the use of an electromagnetic injection nozzle eliminates the need to re-prime the system and/or bleed any air out of the system between uses or refilling of the reservoir 130. Additionally, a rapid duty cycling of the electromagnetic nozzle 220 ensures that the fluid stream “breaks up” which results in a wider and more efficient agent injection into the HVAC duct 105. Lastly, the use of an electromagnetic injection nozzle permits more precise dosing of the agent into the HVAC duct 105. Although the use of electromagnetic injection nozzle has certain advantages, it should be noted that other types of injection nozzles are suitable for use with embodiments of the invention.

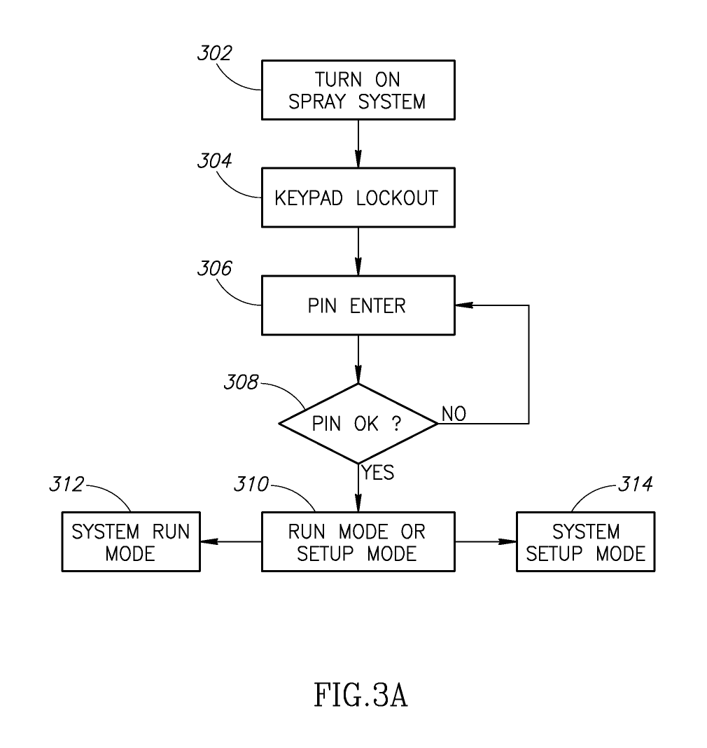

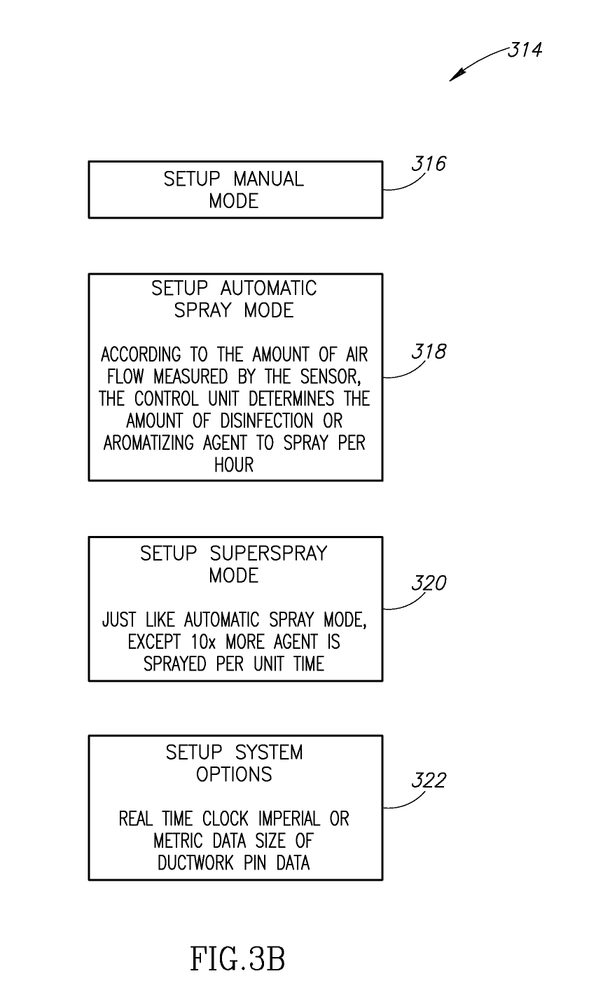

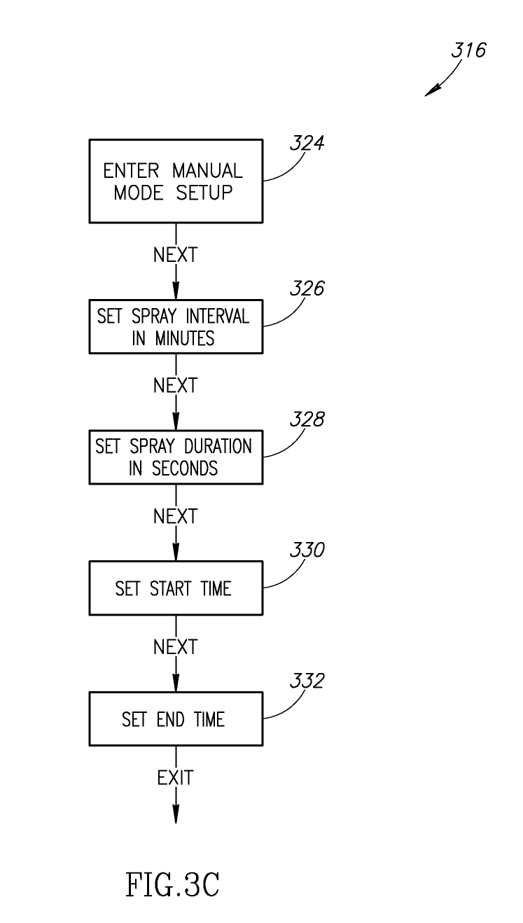

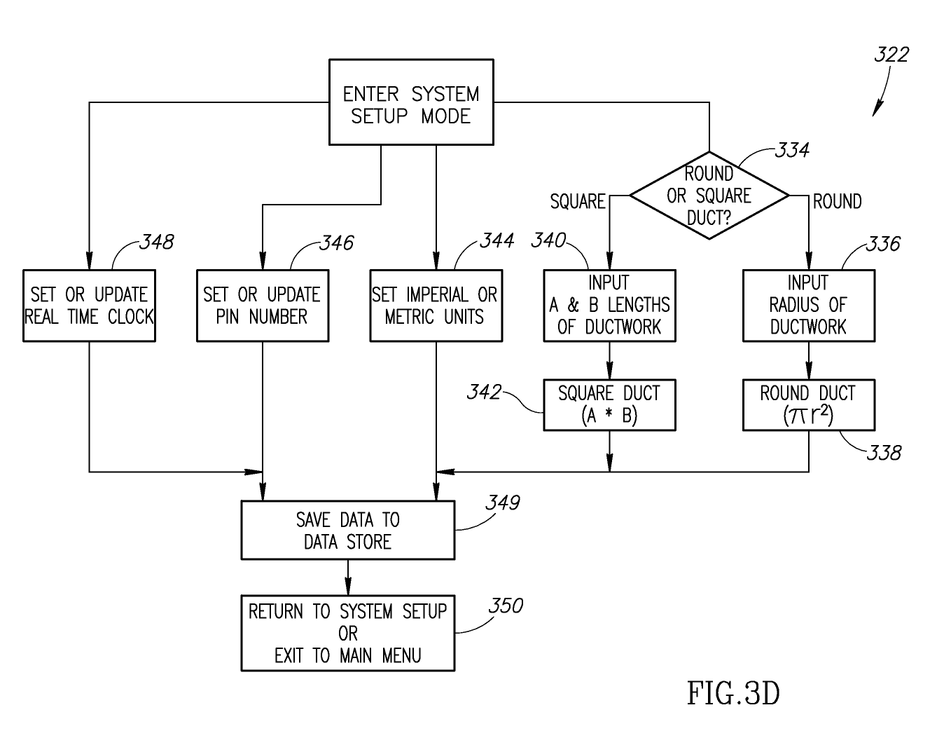

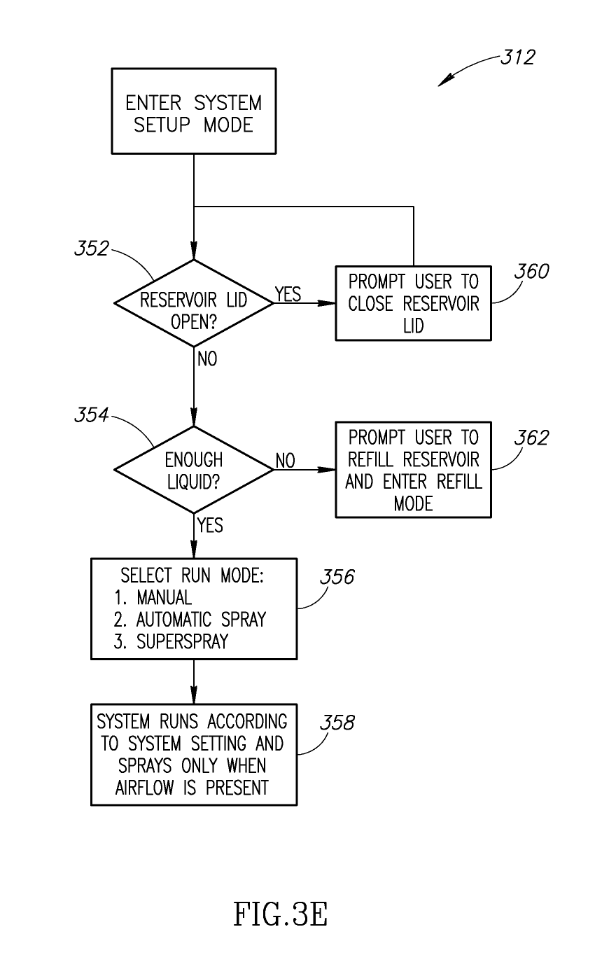

Specific operational aspects of the embodiments shown in FIGS. 1a, 1b, 2a, 2b and 4 will now be discussed with reference to FIGS. 3a-3e. With reference to FIG. 3a, once the system is powered on at step 302, the control module 120 enters a keypad lockout mode at step 304 and refuses to accept any input until such time as a PIN number is correctly entered. After the PIN is entered in step 306, the system attempts to verify the PIN at step 308 before proceeding. If the PIN is entered incorrectly, process flow returns to block 306 in order to allow the user to enter the PIN again. The use of a PIN number helps ensure that only authorized personnel use or operate the system. Because unauthorized personnel may nevertheless attempt to access the system, certain other safeguards may be implemented on embodiments of the invention. For example, if the PIN number is entered incorrectly some predetermined number of times, the software can refuse to accept further attempts to access the system with a PIN, and ask for an alternative identification number. Such an identification number may be for example, a product identification number or some other unique number. If the alternative identification number is also entered incorrectly some predetermined number of times, the system may lock itself permanently until the system is unlocked by a manufacturer or other authorized agent. Once the PIN has been successfully accepted in step 308, an embodiment of the invention may present a menu to the user allowing the selection between system run mode and system setup mode at block 310. At this point, it is possible to configure various aspects of system operation and/or start the injection process. In this example, we assume that this is the first time the system has been switched on and that the system needs an initial setup in order to function properly in the specific implementation.

With reference to FIG. 3b, embodiments of the invention may present a menu of options to the user once system setup mode has been entered at block 314 of FIG. 3a. These menu options may be, for example, setup manual mode 316, setup automatic spray mode 318, setup superspray mode 320, and/or setup systems options 322. Each of these modes will now be discussed in turn.

Supposing, for example, that the user selects setup manual mode 316 from the menu, the process flow of an example setup manual mode is depicted in FIG. 3c. Once the user has elected to enter setup manual mode 316 by selecting the appropriate menu item in the system setup mode 314, the process flow begins at block 324 and proceeds to prompt the user for information needed to execute a manual mode of system operation. At block 326, the user is asked to specify the injection interval in minutes. The injection interval is the number of minutes between discrete injection intervals. Once this information is been accepted by the system, the process moves to block 328 where the user is prompted to set the injection duration in seconds. The injection duration is the number of seconds that the injector should operate during every injection interval. At block 330, the user is prompted to enter the start time for the system to begin operation. The start time is typically a specific time of day, for example 6A.M., or some other time of day. At block 332, the user is similarly prompted to enter the end time at which the system should cease operation. As with the start time, the end time is also a specific time of day, for example 5P.M., or some other time of day. Once this data has been entered by the user and accepted by the system, the data is persisted to a data store 349, as shown in FIG. 3d, for use by the system when the system is put into run mode as will be discussed more fully below. After the manual mode setup data is persisted to the data store 349, setup manual mode 316 exits. In an embodiment, the process flow returns back to system setup mode 314 as depicted in FIG. 3b. In other embodiments, however, the system process flow could return back to block 310 permitting the user to immediately enter run mode instead of setting up further system options or other modes.

Again with reference to FIG. 3b, blocks 318 and 320 permit setup of two similar spray modes. Block 318 permits setup of automatic spray mode while block 320 permit setup of superspray mode. If the user elects to enter block 318 in order to setup automatic spray mode, the system will prompt the user for a dissolution percentage. The dissolution percentage represents the amount of disinfectant or aromatizing agent 250 to be automatically injected into the airflow as a function of the amount of airflow through the HVAC duct 105. The dissolution percentage is typically on the order of 1 or 2% for most applications. By way of example, if the dissolution percentage is set at 1%, then the system will inject agent 250 into the HVAC duct 105 proportional to the volume of air flowing through the duct such that the concentration of injected agent 250 in the resulting airstream is about 1%. Although this embodiment is described in terms of a linear relationship between the volume of an injected agent in the volume of air, it will be understood that in other embodiments nonlinear relationships could be implemented. For example, in another embodiment a predetermined proportion of agent may be injected at low airflows, and some other, larger or smaller, predetermined proportion of agent may be injected at higher airflows. Indeed, virtually any functional relationship between the volume of the injected agent and the volume of airflow may be implemented. Block 320 is a similar setup routine to that of block 318. The superspray mode functions identically to that of the automatic spray mode, except that the dissolution percentage of injected agent is much larger, typically on the order of 10 to 20%. Once a dissolution percentage has been entered by the user in either block 318 or block 320, the data is persisted to the data store 349 as described above.

If the user selects the setup system options 322 from the menu, process flow used is depicted in FIG. 3d as the System Setup Mode 322. The system setup options 322 permits the user to accomplish several setup related tasks such as, for example, set the real-time clock, choose Imperial or metric data for display and entry, specify the size of the HVAC ducts, and change the PIN number required to access the system. A suitable setup function menu will be displayed on the face of the control module 120 when in the System Setup Mode, and the user may select from these or other options. If the user selects the option associated with the real-time clock, process flow passes to block 348 where a suitable menu is displayed for the user in order to set or update the internal real-time clock within the system. Once the real-time clock has been set or updated at block 348, the data associated with the real-time clock is persisted to the data store 349.

The setup system function 322 also permits the user to set or change the PIN number of the control module 120 at block 346. Once the PIN number has been set or updated at block 346, the data associated with the new PIN is persisted to the data store 349.

Block 344 of the setup system options 322 allows the user to specify whether units will be displayed as Imperial units or metric units. Once the unit type has been specified, the data associated with unit type is persisted to the data store 349 and the control module 120 thereafter displays data with the appropriate units.

As discussed above, in the automatic spray mode, the system determines the amount of agent 250 to inject into the HVAC duct 105 as a function of the mass of air flowing through the HVAC duct 105 per unit time. The mass of airflow in the duct per unit time may be computed by multiplying cross-sectional area of the HVAC duct 105 by the flow rate of air through the duct as determined by the airflow sensor 230. The cross-sectional area of the HVAC duct 105 is computed based on data provided in the setup system options 322 starting at block 334. At block 334, the user is prompted to specify whether the HVAC duct 105 is a round duct, or square duct. If the user specifies a round duct at step 334, process flow passes to block 336 where the user is prompted to input the radius of the duct. The cross-sectional area of a round duct is then computed and persisted to the data store 349 at block 338. If instead the user specifies a square duct at step 334, process flow passes to block 340 where the user is prompted to input the width and depth of the duct. The cross-sectional area of a rectangle or duct is then computed and persisted to the data store 349 at block 342. After the user has completed any one of these operations in the setup system mode, system operation may pass back to the setup system options 322, or in other embodiments, back to block 310 of the main menu to choose a mode and/or other set of parameters as shown at block 350 of FIG. 3d.

After system setup has completed, or anytime after the system is turned on and the PIN correctly entered, the user may elect to enter system run mode 312 from block 310 as shown in FIG. 3a. FIG. 3e depicts functional aspects of system run mode 312. Before the system enters operation, the system first determines if the lid of the reservoir 130 is open at step 352. If the lid is open, the user is prompted to close and lock the reservoir lid at block 360 prior to looping back to the normal path of execution. Once the reservoir lid is confirmed closed at block 352, operation passes to block 354 were a check is made to determine if there is a sufficient amount of liquid in the reservoir 130. In the event there is an insufficient quantity of liquid in the reservoir, the user is prompted to refill the reservoir and, in some embodiments, the system enters a refill mode. If, however, there is sufficient liquid in the reservoir, process flow passes to block 356 where the user is prompted to select the mode in which the system should operate. In the embodiments described above, the user would be prompted to select between manual, automatic spray, or superspray modes of operation. In other embodiments, however, additional or different modes of operation are possible. Once a user has selected the desired mode at block 356, the system begins to operate and block 358 according to the system settings and sprays the disinfectant or aromatizing agent into the HVAC duct 105 only when airflow is present, and as a function of the volume of airflow through the HVAC duct 105.

The system operates to spray disinfectant or aromatizing agent 250 into the airflow in the HVAC duct 105 only when airflow is detected in the HVAC duct. The detection of airflow by use of the airflow sensor 230 is not dependent on any control signal from, or mechanical interface with, any equipment which is a part of the HVAC system with which the HVAC injection apparatus 100 of the present invention is used. Embodiments of the HVAC injection apparatus 100 thus provide independent operation without the HVAC injection apparatus risking interfering with the HVAC system, its electronics or mechanical elements, or requiring alteration of the HVAC system. The HVAC injection apparatus 100 of the present invention is a stand-alone unit and is easily added with minimal effort to existing HVAC systems, and uses real-time airflow measurement.

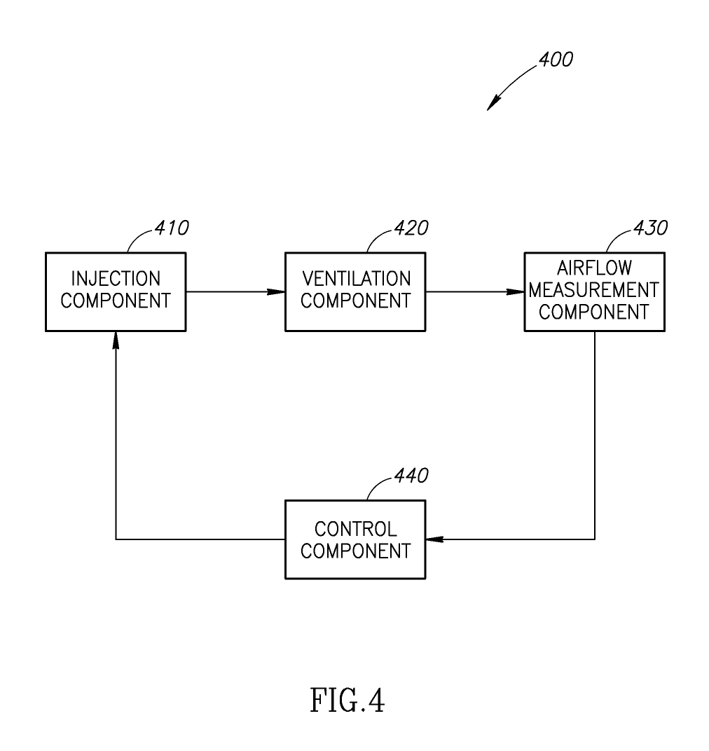

FIG. 4 is a diagram of an HVAC injection system 400 according to an embodiment of the invention. HVAC injection system 400 includes an injection component 410, a ventilation component 420, an airflow measurement component at 430, and a control component 440. The airflow measurement component 430 measures airflow in the ventilation component 420. The airflow measurement generated by the airflow measurement component 430 is passed to the control component 440, and the control component 440 uses the measurement information, and as described above, for example, information such as the cross-sectional area of the ventilation component, to direct the injection component 410 to inject a pre-computed amount of disinfectant and/or aromatization compound into the ventilation component 420.

From the foregoing it will be appreciated that, although specific embodiments of the invention have been described herein for purposes of illustration, it will be understood by one skilled in the art that various modifications may be made without deviating from the invention. Accordingly, the invention is not limited except as by the appended claims.

1. An HVAC injection apparatus comprising:
a reservoir configured to hold a quantity of liquid;
an injection nozzle configured to be coupled to an HVAC duct;
a pump coupled to the reservoir and to the injection nozzle;
an airflow sensor configured to be coupled to the HVAC duct, the airflow sensor configured to detect moving air and measure an airflow speed through the HVAC duct; and
a control module coupled to the pump and to the airflow sensor, the control module configured to actuate the pump to provide a liquid from the reservoir to the injection nozzle, the injection nozzle configured to be controlled by the control module to spray a quantity of the provided liquid into the HVAC duct, the quantity of sprayed liquid being a function of the measured airflow speed.

2. The HVAC injection apparatus of claim 1 wherein the airflow sensor is configured to detect moving air and the HVAC duct, and the control module is configured to actuate the pump to provide liquid from the reservoir to the injection nozzle when air movement in the HVAC duct is detected.

3. The HVAC injection apparatus of claim 1 wherein the injection nozzle is an electromagnetic injection nozzle.

4. The HVAC injection apparatus of claim 3 wherein the injection nozzle is configured to act as a closed valve when the injection nozzle is not actuated.

5. The HVAC injection apparatus of claim 1 wherein the injection nozzle is configured to spray the provided liquid by aerosolizing the liquid.

6. The HVAC injection apparatus of claim 1 wherein the injection nozzle is configured to spray the liquid by atomizing the liquid.

7. The HVAC injection apparatus of claim 1 wherein the control module is further configured to compute the mass of air flowing through the HVAC duct per unit time based on the cross sectional area of the duct and the measured airflow speed through the duct.

8. The HVAC injection apparatus of claim 7 wherein the quantity of sprayed liquid is a linear function of the mass of air flowing through the HVAC duct per unit of time.

9. The HVAC injection apparatus of claim 7 wherein the quantity of sprayed liquid is a nonlinear function of the mass of air flowing through the HVAC duct per unit of time.

10. The HVAC injection apparatus of claim 1 wherein the liquid comprises one of a disinfectant solution and an aromatizing solution.

11. The HVAC injection apparatus of claim 1 wherein the control module is further configured to deactivate the pump if the ambient temperature is below a predetermined temperature.

12. A method of injecting a volume of liquid into an HVAC duct, the method comprising:
computing the mass of air flowing through the HVAC duct per of unit time;
injecting a predetermined volume of liquid into the HVAC duct, the predetermined volume of liquid being a function of the computed mass of air flowing through the HVAC duct per unit of time.

13. The method of claim 12 wherein computing the mass of air flowing through the HVAC duct per unit of time comprises computing the mass of air based on a measurement of the speed of the air flowing through the HVAC duct and the cross sectional area of the HVAC duct.

14. The method of claim 12 wherein injecting the predetermined volume of liquid into the HVAC duct comprises actuating an electromagnetic valve at predetermined times and with a predetermined duty cycle.

15. The method of claim 14 wherein the electromagnetic valve is configured to aerosolize the liquid during actuation.

16. The method of claim 14 wherein the electromagnetic valve is configured to atomize the liquid during actuation.

17. The method of claim 12 wherein the liquid comprises one of a disinfectant and an aromatizing solution.

18. The method of claim 12 the predetermined volume of liquid is a linear function of the mass of air flowing through the HVAC duct per unit time.

19. The method of claim 12 the predetermined volume of liquid is a nonlinear function of the mass of air flowing through the HVAC duct per unit time.

20. The method of claim 12 further including detecting if air is flowing through the HVAC duct and commencing injection of the predetermined volume of liquid into the HVAC duct when airflow in the HVAC duct is detected.

21. The method of claim 12 further including detecting if air is flowing through the HVAC duct and injecting the predetermined volume of liquid into the HVAC duct only when airflow in the HVAC duct is detected.

22. An HVAC injection system comprising:
an injection component configured to be coupled to a ventilation component;
an airflow measurement component configured to be coupled to the ventilation component;
a control component coupled to the injection component and to the airflow measurement component, the control component configured to direct the injection component to inject a quantity of liquid into the ventilation component according to the airflow measured by the airflow measurement component.

23. The HVAC injection system of claim 22 wherein the injection component comprises an electromagnetic valve.

24. The HVAC injection system of claim 22 wherein the ventilation component comprises a duct.

25. The HVAC injection system of claim 22 wherein the airflow measurement component comprises one of: a hotwire anemometer, a cup anemometer, an ultrasonic anemometer, a windmill anemometer and a laser anemometer.

26. The HVAC injection system of claim 22 wherein the control component is further configured to determine the quantity of liquid to inject as a function of the airflow measurement.

27. The HVAC injection system of claim 22 wherein the liquid comprises one of a disinfectant solution and an aromatizing solution.

28. An HVAC ventilation apparatus comprising:
at least one HVAC duct coupled to an air circulation device that intermittently causes airflow through the duct;
a reservoir configured to hold a quantity of liquid;
an injection nozzle coupled to and arranged to inject fluid into the at least one HVAC duct;
a pump coupled to the reservoir and to the injection nozzle;
an airflow sensor coupled to the at least one HVAC duct, the airflow sensor detecting moving air and measuring an airflow speed through the at least one HVAC duct; and
a control module coupled to the pump and to the airflow sensor, the control module actuating the pump to provide a liquid from the reservoir to the injection nozzle and thereby cause the injection nozzle to spray a quantity of the provided liquid into the HVAC duct, the quantity of sprayed liquid being a function of the measured airflow speed.

29. The HVAC ventilation apparatus of claim 28 wherein the control module actuates the pump to provide liquid from the reservoir to the injection nozzle when air movement in the HVAC duct is detected.

30. The HVAC ventilation apparatus of claim 28 wherein the injection nozzle is an electromagnetic injection nozzle.

31. The HVAC ventilation apparatus of claim 30 wherein the injection nozzle acts as a closed valve when the injection nozzle is not actuated.

32. The HVAC ventilation apparatus of claim 28 wherein the injection nozzle sprays the provided liquid by aerosolizing the liquid.

33. The HVAC ventilation apparatus of claim 28 wherein the injection nozzle sprays the liquid by atomizing the liquid.

34. The HVAC ventilation apparatus of claim 28 wherein the control module is further configured to compute the mass of air flowing through the HVAC duct per unit of time based on the cross sectional area of the duct and the measured airflow speed through the duct.

35. The HVAC ventilation apparatus of claim 34 wherein the quantity of sprayed liquid is a linear function of the mass of air flowing through the HVAC duct per unit of time.

36. The HVAC ventilation apparatus of claim 34 wherein the quantity of sprayed liquid is a nonlinear function of the mass of air flowing through the HVAC duct per unit of time.

37. The HVAC ventilation apparatus of claim 28 wherein the control module is further configured to compute the mass of air flowing through the HVAC duct per unit of time based on the temperature of the airflow.

38. The HVAC ventilation apparatus of claim 28 wherein the control module is further configured to compute the mass of air flowing through the HVAC duct per unit of time based on the air pressure of the airflow.

39. The HVAC ventilation apparatus of claim 28 wherein the airflow sensor includes a portion extending into the HVAC duct and positioned upstream from the injection nozzle to thereby avoid the quantity of liquid sprayed into the HVAC duct wetting the airflow sensor.
